(19) United States
(12) Patent Application Publication
(10) Pub. No.: US 2019/0020162 A1
(43) Pub. Date: Jan. 17, 2019

(54) Aircraft rotational joint with a slip-ring device for electrical energy transmission

(71) Applicants: Airbus Operations GmbH, Hamburg (DE); Airbus Operations Limited, Bristol (GB)

(72) Inventors: Russell OLDER, Bristol (GB); Daren HEALY, Bristol (GB); Alan Bennett, Bristol (GB); Dennis Lubczyk, Hamburg (DE)

(21) Appl. No.: 16/034,529

(22) Filed: Jul. 13, 2018

(30) Foreign Application Priority Data
Jul. 14, 2017 (DE) 102017115962.2

(51) Int. Cl. H01R 39/08; B64C 23/06; B64C 13/50

(52) U.S. Cl. CPC H01R 39/08; B64C 13/50; B64C 23/072

(57) ABSTRACT

An aircraft rotational joint comprises a slip-ring device arranged for electrical energy transmission through the rotational joint. The slip-ring device comprises a first member attached to a first part of the rotational joint. The first member has a plurality of arcuate metallic ring segments and all these ring segments are isolated from each other and are spaced apart from each other. Further, the slip-ring device comprises a second member which is rotatable relative to the first member about a common rotational axis. The second member is attached to a second part of the joint and has a plurality of contact elements, each of which are arranged for electrically connecting one, preferably only one, of the ring segments.

### CROSS-REFERENCES TO RELATED APPLICATIONS

This application claims the benefit of the German patent application No. 102017115962.2 filed on Jul. 14, 2017, the entire disclosures of which are incorporated herein by way of reference.

### BACKGROUND OF THE INVENTION

The present invention relates to an aircraft rotational joint comprising a slip-ring device for electrical energy transmission through the rotational or rotary joint. The invention further relates to a wing of an aircraft comprising a main wing and a foldable wing tip device, wherein the foldable wing tip device is connected to the main wing using an aircraft rotational joint.

Several known slip-ring devices for us in rotational joints comprise two main members: a first member with a number of metallic rings, to be fixed on the stationary part of the rotational joint, and a second member with contact elements for the metallic rings, being rotatable relative to the first member and to be fixed on the rotational part of the joint. Such slip-ring devices serve to transmit electrical energy through the rotational joint.

### SUMMARY OF THE INVENTION

An object of the present invention is to provide an improved aircraft rotational joint with a slip-ring device.

The aircraft rotational joint according to the present invention comprises a slip-ring device for electrical energy transmission through the rotational or rotary joint. The slip ring device comprises a first member attached to a first part of the rotational joint. The first member has a plurality of arcuate conductive ring segments. The ring segments are electrically isolated from each other. Further, the slip-ring device comprises a second member attached to a second part of the rotational joint and comprising a plurality of contact elements. Each of the contact elements is in electrical contact with one and preferably only one of the ring segments. The first member and the second member are rotatable relative to each other about a common rotational axis of the aircraft rotational joint. Each of the ring segments extends along a different circular arc segment, wherein the center of each of the circular arc segments is arranged on the common rotational axis. At least two of the ring segments extend along circular arc segments having an identical radius and an identical center.

A first of the ring segments and a first of the contact elements may form a first path for electrical energy transmission while a second of the ring segments and a second of the contact elements may form an independent second path for electrical energy transmission.

In many applications, the angle of rotation of aircraft rotational joints which is required for electrical energy transmission is 180° or less and if the first member of a known slip-ring device has a continuous metallic ring then a section of it will not be used for electrical energy transmission. This unused section could not serve independently for electrical energy transmission. In contrast, the first member of the slip-ring device according to the invention has arcuate conductive, e.g., metallic, ring segments and it may offer the advantage that two such ring segments may form independent paths for electrical energy transmission. The slip-ring device of the aircraft rotational joint according to the invention offers at least two channels arranged at the same distance to the common rotational axis or axis of rotation of the aircraft rotational joint. In other words, at least two ring segments are arranged on the same imaginary circle about the rotational axis without being in electrical contact to one another. Each of the ring segments does not extend about the full circumference of the circle but only extends along a section of the circle. Therefore, the rotational joint according to the present invention may be smaller than known rotational joints including a slip-ring device having the same number of independent paths for electrical energy transmission. Such rotational joints can, in particular, be used for movably connecting a foldable wing tip device to a main wing.

In the following, preferred embodiments are explained which may be advantageously combined with each other unless stated otherwise.

In a preferred embodiment, three or more of the ring segments extend along circular ring segments having an identical center and an identical radius. The circular ring segments are preferably evenly spaced from one another. The second member can have three or more corresponding contact elements each being in electrical contact with just one of the ring segments. Thereby, three or more paths for electrical energy transmission are provided on the same imaginary circle or circumference about the common rotational axis. This may offer the advantage of an even smaller rotational joint.

Preferably, four of the ring segments along circular ring segments have an identical center, an identical radius and are evenly spaced. This may offer the advantage of an even smaller slip-ring device and, therefore, an even more compact rotational joint.

The first member of another preferred embodiment comprises at least one stop element arranged between two of the ring segments extending along circular arc segments having the identical radius and the identical center. The stop element limits the rotation of the first member and the second member relative to one another. The stop element can protrude from the first member towards the second member. The stop element can extend radially from the rotational axis and/or along the rotational axis. The second member can have a protrusion to abut against the stop element. The stop element may be made from an isolating material. There may be two stop elements arranged at different angular positions with respect to the rotational axis, particularly to limit the rotational freedom in opposite directions. In doing so, in this way, inadvertent contact between the contact element of a first path for electrical energy transmission and the ring segment can be avoided to prevent an independent second path for electrical energy transmission. Advantageously, the safety of the slip-ring device used in the aircraft rotational joint is improved.

According to another exemplary preferred embodiment, the slip-ring device of the aircraft rotational joint comprises a housing, particularly for at least one of receiving the second member and isolating the ring segments from the environment. The housing can be connected with the first member. The housing, particularly a wall section of the housing, can serve to stop the rotation of the second member, when the second member abuts against the housing or wall section. Advantageously, the safety of the slip-ring device used in the aircraft rotational joint is improved.

According to another preferred embodiment, the first member is disc shaped. Several ring segments can extend on circular arc segments at different radii from the common rotational axis on the outer surface of the disc shaped first member. On the second member, several contact elements can be spaced radially with respect to the rotational axis from each other for making electrical contact with ring segments that are arranged at different radii from the common rotational axis. This may offer the advantage of keeping the dimension of the slip-ring device and, therefore, the rotational joint, along the rotational axis small while offering many paths for electrical energy transmission.

According to another preferred embodiment, the first member has a cylindrical outer surface extending along the rotational axis. Several ring segments can be arranged on different circumferences on the cylindrical outer surface which are spaced apart from each other along the rotational axis. On the second member, several contact elements can be spaced along the rotational axis from each other for making electrical contact with different ring segments arranged on different circumferences. This may offer the advantage of keeping the dimension of the slip-ring device and, therefore, the rotational joint along the rotational axis small while offering many paths for electrical energy transmission.

In another preferred embodiment, two ring segments extending along circular arc segments having an identical radius and an identical center have different dimensions in at least one of along the common rotational axis and perpendicular to the common rotational axis. In other words, one ring segment is wider than the other ring segment arranged on the same circumference or imaginary circle about the common rotational axis, measured along the rotational axis or perpendicular to the rotational axis. For example, the electrical resistance of one of the ring segments is smaller than the electrical resistance of the other ring segment. Advantageously, the ring segment having a lower electrical resistance may be used for transmitting electrical power requiring high currents while the other ring segment may suffice for transmitting a data signal having a smaller current.

According to another preferred embodiment, two or more ring segments form a first segment group and two or more of the ring segments form a second segment group, wherein the ring segments of the first segment group and the second group are arranged on a plane extending perpendicular to the common rotational axis, and wherein a ring segment of the first segment group and a ring segment of the second segment group extend along circular arc segments having the identical radius and the identical center. Preferably, four segment groups are spaced evenly about the rotational axis. This may offer the advantage of keeping the dimensions of the slip-ring device small while offering many paths for electrical energy transmission.

Further preferred, the ring segments of the first segment group are arranged for transmitting electrical power and the ring segments of the second segment group are arranged for transmitting data signals. The ring segments of the first segment group can be wider than the ring segments of the second segment group, measured along the rotational axis or perpendicular to the rotational axis, particularly to have a smaller electrical resistance as compared to the ring segments of the second segment group. The distance between the ring segments of the first segment group may be wider than the distance between the ring segments of the second segment group, particularly for improved insulation. Advantageously, the safety of the slip-ring device is improved.

In another preferred embodiment, the first member and the second member have a recess or through-hole extending along the rotational axis. Thereby, the slip-ring device is arranged about an axle, a shaft, a geared rotary actuator or another mechanical part of the rotational joint. This may help to reduce the overall size of the rotational joint.

According to another preferred embodiment, the contact elements are biased towards the ring segments of the same path for electrical energy transmission. The contact element can be spring-loaded. A pushing device of the second member serves to urge one or more of the contact elements towards the ring segments. Advantageously, the electrical contact between the contact element and the ring segment can be improved and/or the electrical resistance reduced.

In another preferred embodiment, the second member comprises a connecting element supporting two or more of the contact elements. The contact elements can be accepted in recesses of the connecting element, preferably together with a spring biasing the contact element towards the respective ring segment. The connecting element or connecting means can be arranged on the second member to abut against one of the stop elements of the first member during assembly or at a predetermined angular position to prevent the contact elements of a first path for electrical energy transmission making inadvertent electrical contact with the ring segments of an independent second path for electrical energy transmission. This embodiment may offer the advantage of increased resistance against vibrations and/or simplified assembly of the slip-ring device.

Further preferred, two or more of the connecting elements are, preferably evenly, distributed about the common rotational axis. Particularly in combination with ring segments being arranged in two or more groups on the first member, the slip-ring device can advantageously have more paths for electrical energy transmission at a given size. This embodiment may offer the advantage of increased resistance against vibrations and/or simplified assembly of the slip-ring device.

According to another preferred embodiment, the first and second members have mechanical connectors for connecting with parts of the rotational joint. One or more of these mechanical connectors can be an arm or protrusion extending from the first and second members and/or lugs. Advantageously, connecting of the first and second member with parts of the rotational joint may be simplified.

Another preferred embodiment has two disc shaped first members spaced apart along the rotational axis, wherein the second member is arranged between the first members for electrically connecting ring segments of one of the first members, particularly for electrically connecting ring segments of both of the first members. This embodiment of the slip ring device may advantageously offer more paths for electrical energy transmission while keeping the size and/or number of parts smaller.

In a second aspect the problem underlying the present invention is solved by a wing of an aircraft comprising a main wing and a foldable wing tip device, wherein at least one aircraft rotational joint connects the foldable wing tip device to the main wing.

### BRIEF DESCRIPTION OF THE DRAWINGS

Further advantages of the invention are apparent from the enclosed figures showing illustrative examples of the slip-ring device, wherein

FIG. 1 shows an inside of an exemplary slip-ring device of an aircraft rotational joint with ring segments arranged in groups on a disc shaped first member,

FIG. 2 shows a slip-ring device of an aircraft rotational joint with two first members according to FIG. 1 and isolated from each other,

FIG. 3 shows a wing section with an aircraft rotational joint and a built in slip-ring device with disc shaped first member,

FIG. 4 shows an enlarged section of FIG. 3,

FIG. 5 shows the wing section of FIG. 3 from a different angle,

FIG. 6 shows another exemplary slip-ring device of an aircraft rotational joint with a first member having a cylindrical outer surface,

FIG. 7 shows the slip-ring device of FIG. 6, the second member depicted transparently,

FIG. 8 shows the slip-ring device of FIG. 7 from a different angle,

FIG. 9 shows a wing section with an aircraft rotational joint and a built in slip-ring device according to FIG. 6,

FIG. 10 shows the wing section including the built in slip-ring device according to FIGS. 6 and 9 from a different angle,

FIG. 11 shows the wing section including the built in slip-ring device according to FIGS. 6 and 9 from a different angle and

FIG. 12 shows an aircraft wing comprising a foldable wing tip device.

### DETAILED DESCRIPTION OF THE PREFERRED EMBODIMENTS

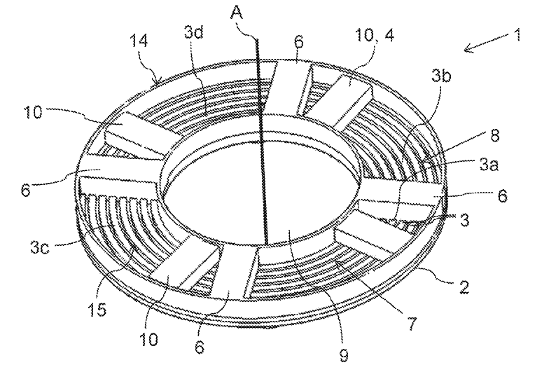

FIG. 1 schematically shows the inside of a slip-ring device 1 of an aircraft rotational joint. The rotational joint is used for movably or rotatably connecting a foldable wing tip device to a main wing of an aircraft. The slip-ring device 1 is arranged for electrical energy transmission through an aircraft rotational joint. It comprises a first member 2 attached on a first part of the rotational joint. The first member has a plurality of arcuate conductive ring segments 3. In the embodiments shown in the Figures the ring segments are metal ring segments 3. Only two of the ring segments 3 have been indicated with reference numbers to keep the drawings intelligible. The ring segments 3 are electrically isolated from each other, e.g., by arranging them spaced apart from one another. Further, the slip-ring device comprises a second member (not shown in FIG. 1) which is rotatable relative to the first member about a common rotational axis A which is also the axis of rotation of the aircraft rotational joint. The second member is attached to a second part of the rotational joint and has a plurality of contact elements (not shown in FIG. 1), each of which are in electrical contact with only one of the ring segments 3.

The ring segments 3 are arranged in four segment groups 7, 8, 14, 15 on the disc shaped first member 2. The second member (not shown) of the slip-ring device 1 has four connecting elements 10, which support the spring loaded contact elements (not shown) for electrical contact with the ring segments 3. All ring segments 3 extend along circular arc segments. The center of each of these arc segments coincides with the common rotational axis A, i.e., the arc segments and therefore the ring segments 3 are arranged on imaginary circles about the common axis of rotation or rotational axis A. Four ring segments 3a, 3b, 3c, 3d, one of the each segment group 7, 8, 14, 15, extend along circular arc segments that have an identical radius and an identical center. In other words, always four of the ring segments 3a, 3b, 3c, 3d are arranged on the same circumference about the common rotational axis A on the first member 2, particularly on an outer surface of the first member 2. Only one set of four ring segments 3a, 3b, 3c, 3d has been designated in the FIG. 1 to avoid overcomplicating FIG. 1. However, it is readily apparent for the skilled person from the drawings that multiple sets of ring segments extending along circular arc segments with an identical radius and in identical center can be designated in the FIG. 1.

In a first segment group 7 the ring segments 3 are arranged on different circumferences, i.e., they extend along circular arc segments having different radii about the common rotational axis A. However, the ring segments 3 of the first group are preferably arranged within the same sector or angular range about the common rotational axis. A ring segment 3a of the first segment group 7 extends along an arc segment having the identical radius and the identical center as a circular arc segment along which the ring segment 3b of the second segment group 8 extends.

The segments groups 7, 8, 14, 15 and their ring segments 3 are separated by stop elements 6 arranged between ring segments on the first member. Against the stop elements 6 the connecting elements can abut when the second member is rotated relative to the first member 2. Further, the stop elements 6 provide electrical isolation between the ring segments 3 of the different segment groups 7, 8, 14, 15. The stop elements 6 are optional and may, for example, be replaced by stop elements of the rotational joint.

The first and second members have a through-hole 9 for receiving a part of the rotational joint such as a shaft or a geared rotary actuator.

FIG. 2 shows a slip-ring device 1 of an aircraft rotational joint with two first members 2 according to FIG. 1 and electrically isolated from each other. In all Figures like elements are designated with like reference numerals. The slip-ring device 1 also has two second members 4 according to FIG. 1. The members 2, 4 are stacked as follows: first member 2-second member 4-second member 4-first member 2. This example offers more paths for electrical energy transmission or redundancy by parallel connection of the two first members 2, depending on the cable harnesses which are not shown in the Figures.

Alternatively but not shown, a single second member 4 could electrically contact the ring segments 3 of both first members 2 to reduce the number of parts of the slip-ring device 1.

FIG. 3 shows a wing section 31 with a rotational joint 32 and a built in slip-ring device 1 according to FIG. 1 with a disc shaped first member 2. The first member 2 is connected with the first part 22 of the rotational joint 32 and the second member 4 is connected with the second part 23 of the rotational joint 32.

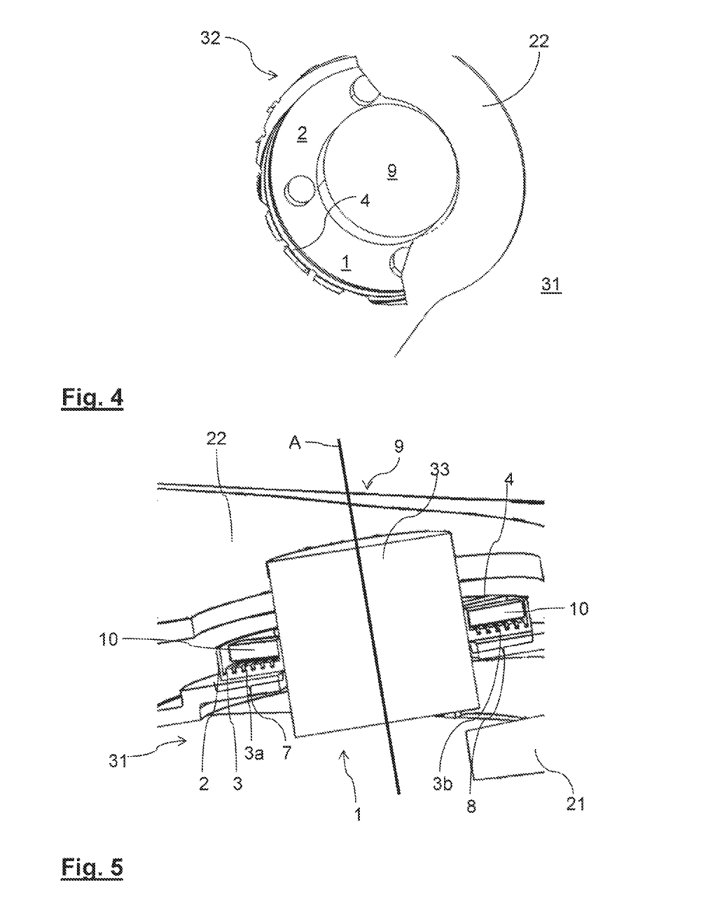

FIG. 4 shows an enlarged section of FIG. 3.

FIG. 5 shows a sectional view of the wing section 31 of FIG. 3 from a different angle. The arcuate metallic ring segments 3 are arranged on a disc shaped first member 2, as already explained with respect to FIG. 1. Also, connecting means 10 of the second member 4 are arranged adjacent to the ring segments 3 and support the contact elements (not shown) of the second member 4 for electrical contact with ring segments 3. The first member 2 is connected with the stationary part 21 of the rotational joint 31 and the second member 22 is connected with the rotatable part 22 of the rotational joint 31. In FIG. 5 a shaft 33 extends through the opening 9 in the center of the slip-ring device 1.

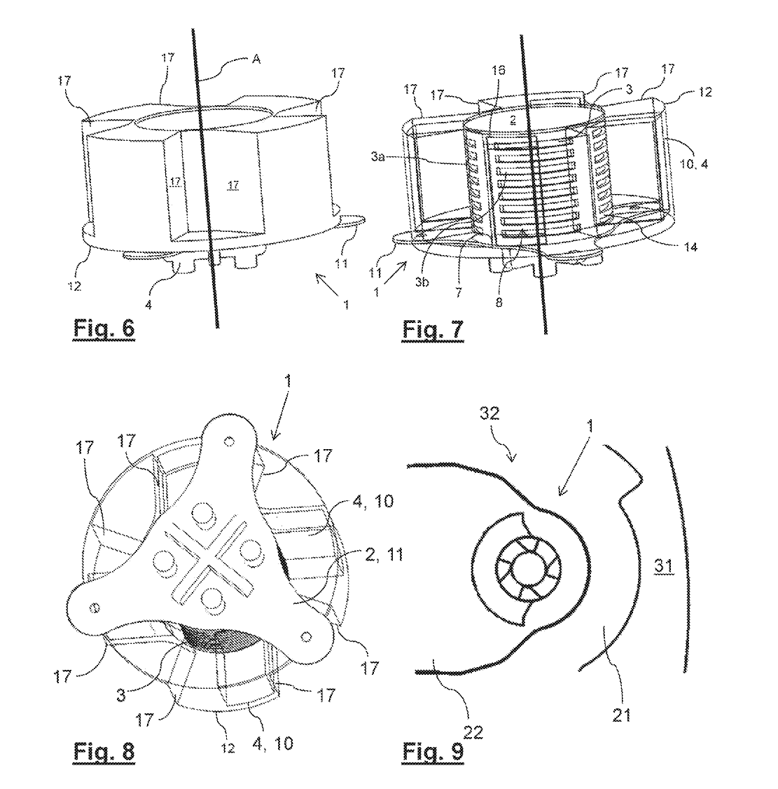

FIGS. 6 to 11 show another exemplary slip-ring device 1 of an aircraft rotational joint. The slip-ring device 1 is arranged for electrical energy transmission through the rotational joint. It comprises a first member 2 attached to a first part of the rotational joint. The first member 2 has a plurality of arcuate metallic ring segments 3. The ring segments 3 are isolated from one another and also spaced apart from one another. Further, the slip-ring device 1 comprises a second member 4 which is rotatable relative to the first member 2 about a common rotational axis A which is also the rotational axis of the aircraft rotary joint. The second member is attached to a second part of the rotational joint and has a plurality of contact elements (not shown), each of which are arranged for electrically connecting exactly one of the ring segments 3.

The first member 2 has a cylindrical outer surface 16. The first member 2 is sectionally surrounded by the second member 4. On the cylindrical surface 16 of the first member 2, the ring segments 3 are arranged in four groups 7, 8, 14, 15 and the second member comprises four connecting elements 10 each supporting several contact elements (not shown). The slip-ring device 1 comprises a housing 12 receiving the second member 4. Wall sections 17 of the housing 12 serves to limit the rotation of the second member 4 relative to the first member 2.

FIG. 7 shows the slip-ring device 1 of FIG. 6, the housing 12 being depicted transparently. The ring segments 3 are arranged in four segment groups 7, 8, 14, 15 on the cylindrical outer surface 16 of the first member 2. The first member 2 has three arms 11 with holes for a mechanical connection with the first part 21 of the rotational joint 32. The second member 4 inside the housing 12 has four connecting elements 10 supporting contact elements (not shown). Wall sections 17 of the housing 12 serve to limit the rotation of the second member 4 relative to the first member 2.

FIG. 8 shows the slip-ring device 1 of FIG. 7 from a different angle. Bosses on the underside of the first member 2 are for electrical connection with its ring members.

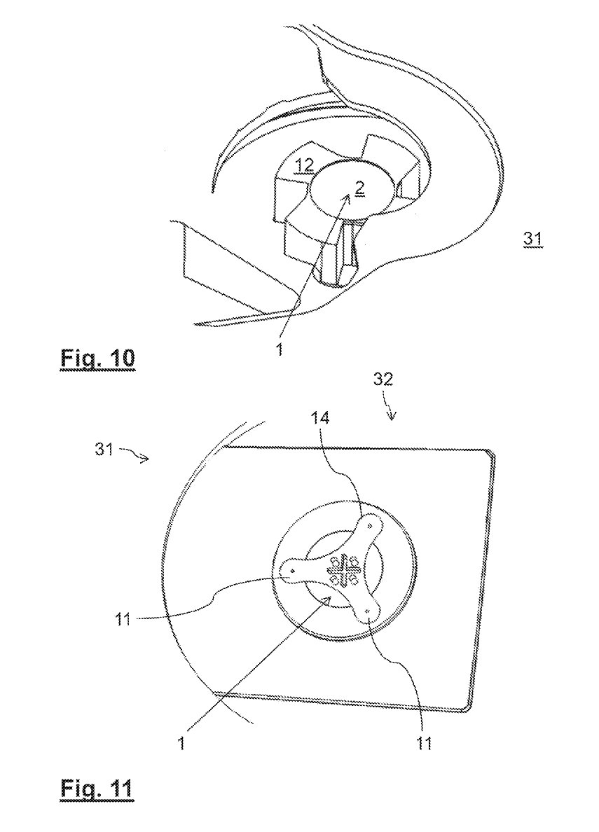

FIG. 9 shows a wing section 31 with a rotational joint 32 and a built in slip-ring device 1 according to FIGS. 6 to 8. The first member 2 of the slip-ring device 1 is mechanically connected with the stationary part 21 and the second member 4 is mechanically connected with the rotational part 22 of the rotational joint 31.

FIG. 10 shows the wing section 31 of FIG. 9 including the built in slip-ring device 1 according to FIGS. 6 to 9 from a different angle.

FIG. 11 shows the wing section of FIGS. 9, 10 including the built in slip-ring device 1 according to FIGS. 6 to 9 from the underside. The first member 2 has mechanical connectors 11 for the mechanical connection with the stationary part 21.

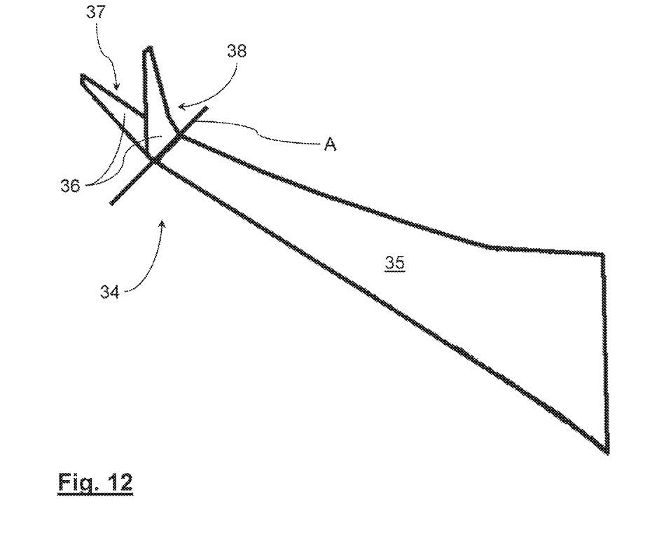

Finally, FIG. 12 shows a wing 34 of an aircraft comprising a main wing 35 and a foldable wing tip device 36. The foldable wing tip device 36 is shown in an extended position denoted by reference numeral 37 and a retracted folded position denoted by reference numeral 38. The foldable wing tip device 36 is rotatably mounted or connected to the main wing 35 using at last one exemplary embodiment of a rotational joint 31 according to the present invention. The rotational joint 31 is not shown in FIG. 12. However, the rotational axis A of the at least one rotational joint coincides with the axis about which the foldable wing tip device 36 rotates relative to the main wing 35.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft rotational joint comprising a slip-ring device for electrical energy transmission through the aircraft rotational joint, the slip-ring device comprising:
a first member attached to a first part of the rotational joint, the first member comprising a plurality of arcuate conductive ring segments, wherein the ring segments are electrically isolated from each other,
a second member attached to a second part of the aircraft rotational joint, the second member comprising a plurality of contact elements, wherein each of the contact elements is in electrical contact with one of the ring segments,
wherein the first member and the second member are rotatable relative to each other about a common rotational axis which is also the rotational axis of the aircraft rotational joint,
wherein each of the ring segments extends along a different circular arc segment, wherein a center of each of the circular arc segments is arranged on the rotational axis, and
wherein at least two of the ring segments extend along circular arc segments having an identical radius and an identical center.

2. The aircraft rotational joint according to claim 1, wherein three or more of the ring segments extend along circular arc segments having an identical center and an identical radius, wherein the circular arc segments are preferably evenly spaced from one another.

3. The aircraft rotational joint according to claim 1, wherein the first member comprises at least one stop element arranged between two ring segments extending along circular arc segments having an identical radius and an identical center, wherein the stop element is adapted to limit a rotation of the second member relative to the first member.

4. The aircraft rotational joint according to claim 1, wherein the first member is disc shaped or has a cylindrical outer surface extending along the common rotational axis.

5. The aircraft rotational joint according to claim 1, wherein two ring segments extending along circular arc segments having an identical radius and an identical center have different dimensions in at least one of along the common rotational axis and perpendicular to the common rotational axis.

6. The aircraft rotational joint according to claim 1, wherein two or more of the ring segments form a first segment group and two or more of the ring segments form a second segment group, wherein the ring segments of the first segment group and the second segment group are arranged in a plane extending perpendicular to the common rotational axis and wherein a ring segment of the first segment group and a ring segment of the second segment group extend along circular arc segments having the identical radius and the identical center.

7. The aircraft rotational joint according to claim 6, wherein the ring segments of the first segment group are arranged for transmitting power and the ring segments of the second segment group are arranged for transmitting data signals.

8. The aircraft rotational joint according to claim 1, wherein the first member and the second member have a recess or through-hole extending along the rotational axis.

9. The aircraft rotational joint according to claim 1, wherein the contact elements are biased towards the ring segments, wherein the contact elements are spring loaded.

10. The aircraft rotational joint according to claim 1, wherein the second member comprises at least one connecting element supporting two or more of the contact elements.

11. The aircraft rotational joint according to claim 10, wherein two or more of the connecting elements are evenly distributed about the common rotational axis.

12. The aircraft rotational joint according to claim 1, wherein the first and second members have mechanical connectors connected with parts of the rotational joint.

13. The aircraft rotational joint according to claim 1, further comprising two disc shaped first members spaced apart along the common rotational axis, wherein the second member is arranged between the first members for electrically contacting ring segments of one of the first members.

14. A wing of an aircraft comprising a main wing and a foldable wing tip device, wherein at least one aircraft rotational joint according to claim 1 connects the foldable wing tip device to the main wing.
